(19) United States
(12) Patent Application Publication
(10) Pub. No.: US 2008/0252632 A1
(43) Pub. Date: Oct. 16, 2008

(54) GAMMA VOLTAGE GENERATING CIRCUIT AND DISPLAY DEVICE HAVING THE SAME

(75) Inventors: Chang-Jin Im, Seoul (KR); Hisashi Kimura, Suwon-si (KR); Moon-Chul Park, Seoul (KR); Se-Chun Oh, Seongnam-si (KR); Jong-Won Moon, Yongin-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/035,034

(22) Filed: Feb. 21, 2008

(30) Foreign Application Priority Data
Apr. 13, 2007 (KR) 10-2007-0036336

(51) Int. Cl. G09G 3/36; G09G 5/00

(52) U.S. Cl. 345/209; 345/99

(57) ABSTRACT

A gamma voltage generating circuit includes a resistor string part including a plurality of resistors electrically connected in series between a first power terminal and a second power terminal, the first power terminal receives a first power voltage and the second power terminal receives a second power voltage. The resistor string part outputs a plurality of gamma voltages. A first resistor part includes a first electronic device electrically connected in parallel with a first resistor. The first resistor part is electrically connected in series between the first power terminal and a first terminal of the resistor string part and a second resistor part includes a second electronic device electrically connected in parallel with a second resistor. The second resistor part is electrically connected in series between the second power terminal and a second terminal of the resistor string part.

This application claims priority to Korean Patent Application No. 2007-36336, filed on Apr. 13, 2007, and all the benefits accruing therefrom under 35 U.S.C. §119, the contents of which in its entirety are herein incorporated by reference.

### BACKGROUND OF THE INVENTION

1. Field of the Invention

The present invention relates to a gamma voltage generating circuit and a display device having the gamma voltage generating circuit. More particularly, the present invention relates to a gamma voltage generating circuit capable of decreasing manufacturing costs thereof and a display device having the gamma voltage generating circuit.

2. Description of the Related Art

Generally, a liquid crystal display (“LCD”) panel includes a gate line, a source line, a switching element and a pixel electrode. The gate line and the source line are formed from different metal layers. The switching element is electrically connected to the gate line and the source line. The pixel electrode is formed from a transparent conductive material which is electrically connected to the switching element. The LCD panel includes a common electrode facing the pixel electrode. The pixel electrode, the common electrode and a liquid crystal layer interposed between the pixel electrode and the common electrode define a liquid crystal capacitor. A storage common electrode formed from the gate metal layer and the pixel electrode define a storage capacitor.

The LCD panel includes a liquid crystal capacitor, a storage capacitor and a parasitic capacitor between a gate electrode and a source electrode of the switching element. The liquid crystal capacitor, the storage capacitor and the parasitic capacitor may define a kickback voltage ‘Vck’, which is defined by the following Equation 1.

$$Vck = \frac{Cgs}{Clc + Cst + Cgs} ( Von - Voff ) \qquad Equation 1$$

wherein ‘Vck’ represents a kickback voltage, ‘Clc’ represents a liquid crystal capacitance of a liquid crystal capacitor, ‘Cst’ represents a storage capacitance of a storage capacitor, ‘Cgs’ represents a parasitic capacitance between a gate electrode and a source electrode, ‘Von’ represents a gate-on voltage and ‘Voff’ represents a gate-off voltage. Here, the liquid crystal capacitance Clc is defined by εA/d, wherein ‘ε’ represents a dielectric constant of liquid crystal, ‘A’ represents a size of a pixel electrode and ‘d’ represents a cell gap of a liquid crystal layer.

Referring to Equation 1, the liquid crystal capacitance Clc has a value according to a liquid crystal phase, so that the kickback voltage Vck has a different value in every gradation. For example, when the liquid crystal molecules are in a twisted nematic (“TN”) mode and a normally white mode, the kickback voltages of each of 64 gradations, for example, are defined by the following Equation 2.

Vck(0Gray)<Vck(1Gray)<, . . . , <Vck(32Gray)<, . . . , <Vck(62Gray)<Vck(63Gray) Equation 2

As shown in Equation 2, due to the difference of kickback voltages of each gradation, when a gamma reference voltage is set by a unique kickback voltage, flickering, afterimages, etc., may be generated.

### BRIEF SUMMARY OF THE INVENTION

The present invention provides a gamma voltage generating circuit having a simple circuit structure.

The present invention also provides a display device having the gamma voltage generating circuit.

In one exemplary embodiment of the present invention, a gamma voltage generating circuit includes a resistor string part, a first resistor part and a second resistor part. The resistor string part includes a plurality of resistors connected in series between a first power terminal receiving a first power voltage and a second power terminal receiving a second power voltage. The resistor string part outputs a plurality of gamma voltages. The first resistor part includes a first electronic device connected in parallel with a first resistor. The first resistor part is connected in series between the first power terminal and a first terminal of the resistor string part. The second resistor part includes a second electronic device connected in parallel with a second resistor. The second resistor part is connected in series between the second power terminal and a second terminal of the resistor string part.

In another exemplary embodiment of the present invention, a display device includes a display panel, a voltage generating part and a gamma voltage generating part. The display panel includes a pixel part connected to a source line and a gate line crossing the source line. The pixel part includes a liquid crystal capacitor. The voltage generating part provides the liquid crystal capacitor with a first common voltage and a second common voltage which are inverted with respect to a reference voltage. The gamma voltage generating part generates a plurality of first polarity gamma voltages and a plurality of second polarity gamma voltages. The gamma voltage generating part includes a resistor string part, a first resistor part and a second resistor part. The resistor string part includes a plurality of resistors connected in series between a first power terminal receiving a first power voltage and a second power terminal receiving a second power voltage. The first resistor part includes a first electronic device connected in parallel with a first resistor. The first resistor part is connected to a first terminal of the resistor string part. The second resistor part includes a second electronic device connected in parallel with a second resistor. The second resistor part is connected to a second terminal of the resistor string part.

According to the exemplary embodiments of a gamma voltage generating circuit and the exemplary embodiments of a display device having the gamma voltage generating circuit of the present invention, display quality may be enhanced. Furthermore, a gamma voltage generating circuit may be simplified, such that manufacturing costs of the gamma voltage generating circuit and the display device may be decreased.

### BRIEF DESCRIPTION OF THE DRAWINGS

The above and other aspects, features and advantages of the present invention will become readily apparent by reference to the following detailed description when considered in conjunction with the accompanying drawings, in which:

FIG. 1 is a schematic top plan view illustrating an exemplary embodiment of a display device according to the present invention;

FIG. 2 is a schematic block diagram illustrating an exemplary embodiment of a driving apparatus of FIG. 1;

FIG. 3 is a circuit schematic diagram according to a first exemplary embodiment of the gamma voltage generating part of FIG. 2;

FIG. 4 is a partial circuit schematic diagram illustrating an exemplary embodiment of a source driving part of FIG. 2;

FIG. 5A is a circuit schematic diagram illustrating the exemplary embodiment of a gamma voltage generating part of FIG. 3 operating in a first mode;

FIG. 5B is a graph illustrating a voltage-transmittance (“V-T”) curve of a first polarity in the first mode shown in FIG. 5A;

FIG. 6A is a circuit schematic diagram illustrating the exemplary embodiment of a gamma voltage generating part of FIG. 3 operating in a second mode;

FIG. 6B is a graph illustrating a V-T curve of a second polarity in the second mode shown in FIG. 6A;

FIG. 7 is a circuit schematic diagram according to a second exemplary embodiment of the gamma voltage generating part of FIG. 2;

FIG. 8A is a circuit schematic diagram illustrating the exemplary embodiment of a gamma voltage generating part of FIG. 7 operating in a first mode; and

FIG. 8B is a circuit schematic diagram illustrating the exemplary embodiment of a gamma voltage generating part of FIG. 7 operating in a second mode.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

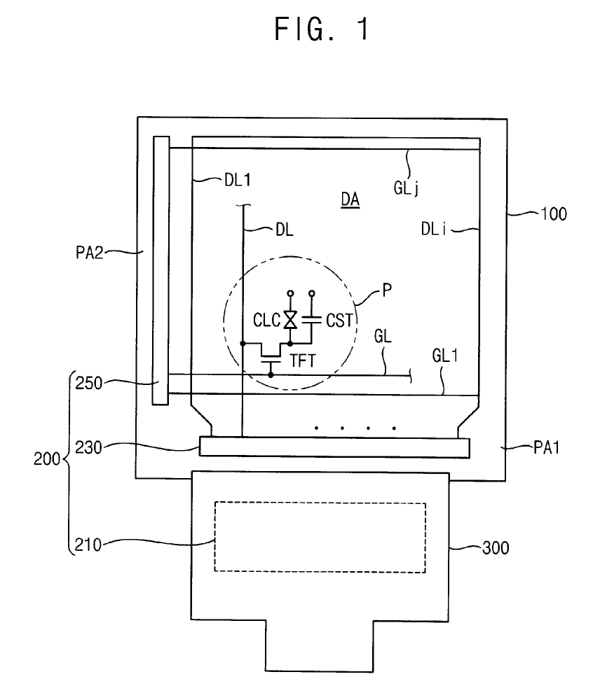

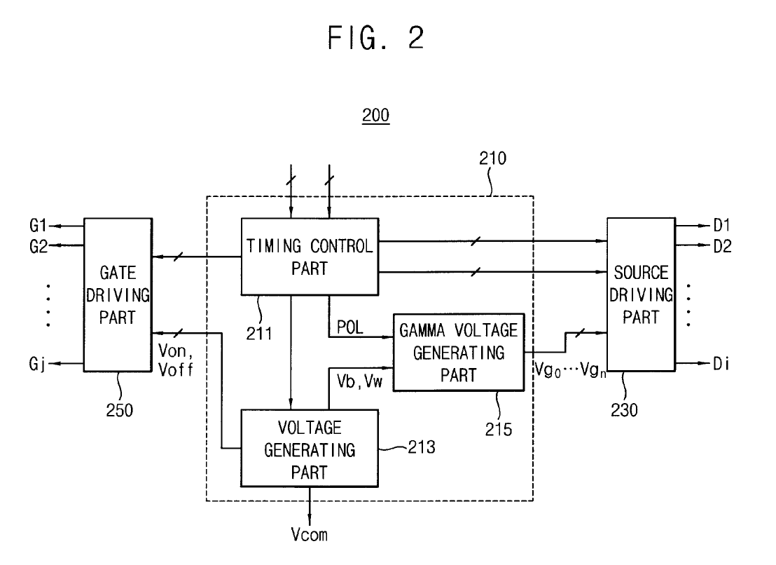

FIG. 1 is a schematic top plan view illustrating an exemplary embodiment of a display device according to the present invention. FIG. 2 is a schematic block diagram illustrating an exemplary embodiment of a driving apparatus of FIG. 1.

Referring to FIGS. 1 and 2, a display device includes a display panel 100 and a driving apparatus 200 which drives the display panel 100.

The display panel 100 includes a display area DA which displays an image, and first and second peripheral areas PA1 and PA2 which surround the display area DA. A plurality of pixel parts P electrically connected to a plurality of source lines DL1 to DLi and to a plurality of gate lines GL1 to GLj is formed in the display area DA. Here, ‘i’ and ‘j’ are natural numbers. Each of the pixel parts P includes a switching element TFT, a liquid crystal capacitor CLC and a storage capacitor CST. In the current exemplary embodiment, the display panel 100 is in a twisted nematic (“TN”) mode and a normally white mode.

The driving apparatus 200 includes a main driving part 210, a source driving part 230 and a gate driving part 250. The main driving part 210 is disposed on a flexible printed circuit board (“FPCB”) 300, which is electrically connected to the display panel 100. The source driving part 230 is disposed in the first peripheral area PA1 adjacent to end portions of the source lines DL1 to DLi, and the gate driving part 250 is disposed in the second peripheral area PA2 adjacent to end portions of the gate lines GL1 to GLj.

The main driving part 210 includes a timing control part 211, a voltage generating part 213 and a gamma voltage generating part 215. The timing control part 211 provides the source driving part 230 with a data signal received from an external device (not shown). The timing control part 211 controls an operation of the main driving part 210, the source driving part 230 and the gate driving part 250 based on a horizontal synchronizing signal and a vertical synchronization signal which are received from the external device.

The voltage generating part 213 generates a plurality of driving voltages, and outputs the driving voltages in response to the control of the timing control part 211. In an exemplary embodiment, the voltage generating part 213 provides the liquid crystal capacitor CLC with a first common voltage VcomH and a second common voltage VcomL, and the voltage generating part 213 provides the gamma voltage generating part 215 with a first power voltage Vb and a second power voltage Vw. The voltage generating part 213 provides the gate driving part 250 with gate driving voltages Von and Voff.

Each of the first and second common voltages VcomH and VcomL is synchronized with the horizontal synchronizing signal, and is swung to include a phase opposite to a reference voltage. In an exemplary embodiment, the voltage generating part 213 provides the liquid crystal capacitor CLC with a first positive common voltage VcomH with respect to the reference voltage during an (N)-th horizontal interval, and the voltage generating part 213 provides the liquid crystal capacitor CLC with a second negative common voltage VcomL with respect to the reference voltage during an (N+1)-th interval. Here, ‘N’ is a natural number.

The first and second power voltages Vb and Vw include a phase opposite to the reference voltage. A voltage difference between the first power voltage Vb and the reference voltage is substantially equal to a voltage difference between the second power voltage Vw and the reference voltage. Each of the first and second power voltages Vb and Vw is synchronized with the horizontal synchronizing signal, and each of the first and second power voltages Vb and Vw is swung to include a phase opposite to the reference voltage.

The gamma voltage generating part 215 divides the first and second power voltages Vb and Vw into a plurality of gamma voltages in order to output the divided gamma voltages. In an exemplary embodiment, the gamma voltage generating part 215 outputs negative gamma voltages corresponding to the first positive common voltage VcomH during the (N)-th horizontal interval based on a line inversion signal POL provided from the timing control part 211, and the gamma voltage generating part 215 outputs positive gamma voltages corresponding to the second negative common voltage VcomL during the (N+1)-th horizontal interval. In the current exemplary embodiment, the first power voltage Vb is less than the second power voltage Vw during the (N)-th horizontal interval, and the first power voltage Vb is larger than the second power voltage Vw during the (N+1)-th horizontal interval.

The source driving part 230 converts data signals provided from the timing control part 211 into analog type data signals D1 to Di using the gamma voltages, and the source driving part 230 outputs the analog type data signals D1, . . . , Di to the source lines DL1 to DLi. In an exemplary embodiment, the source driving part 230 outputs a negative gradation voltage to the source lines DL1 to DLi using the negative gamma voltages during the (N)-th horizontal interval, and the source driving part 230 outputs a positive gradation voltage to the source lines DL1, . . . , DLi using the positive gamma voltages during the (N+1)-th horizontal interval.

The gate driving part 250 generates gate signals G1 to Gj using the gate-on/off voltages Von and Voff based on the control of the timing control part 211, and the gate driving part 250 outputs the gate signals G1 to Gj to the gate lines GL1 to GLj.

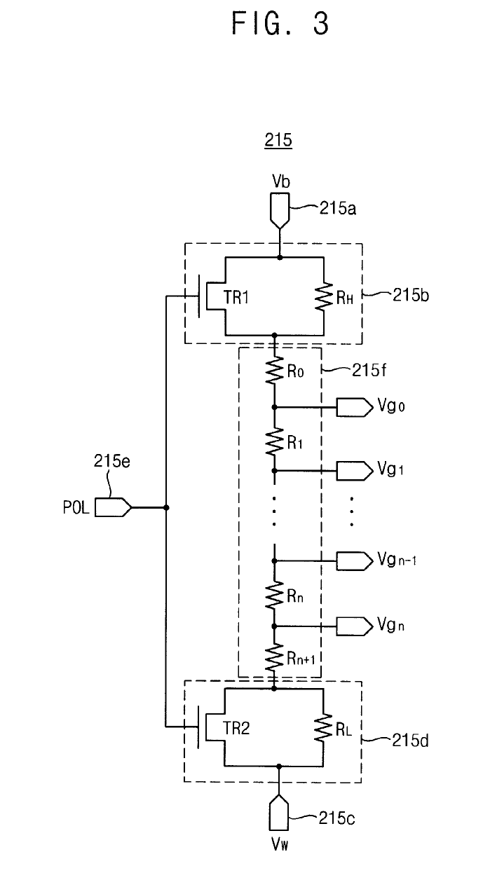

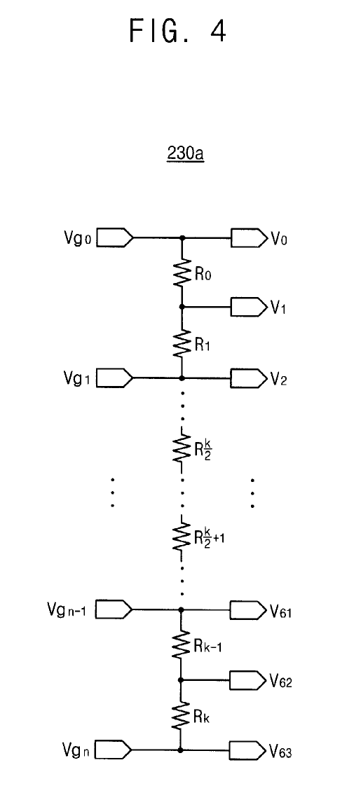

FIG. 3 is a circuit schematic diagram according to a first exemplary embodiment of the gamma voltage generating part of FIG. 2. FIG. 4 is a partial circuit schematic diagram illustrating the source driving part of FIG. 2.

Referring to FIG. 3, a gamma voltage generating part 215 includes a first power terminal 215a, a first resistor part 215b, a second power terminal 215c, a second resistor part 215d, a control terminal 215e and a resistor string part 215f.

The first power terminal 215a receives the first power voltage Vb.

The first resistor part 215b includes a first transistor TR1 and an upper resistor RH which are electrically connected in parallel. The first resistor part 215b is electrically connected in series to the first power terminal 215a and to a first terminal of the resistor string part 215f. When the first transistor TR1 is turned on, the first resistor part 215b is in a shorted state such that a resistance value is substantially zero in accordance with characteristics of a parallel resistor. When the first transistor TR1 is turned off, the first resistor part 215b includes a resistance value equal to that of the upper resistor RH.

The second power terminal 215c receives a second power voltage Vw including a phase opposite to the first power voltage Vb with respect to a reference voltage.

The second resistor part 215d includes a second transistor TR2 and a lower resistor RL which are electrically connected in parallel. The second resistor part 215d is electrically connected in series to the second power terminal 215c and to a second terminal of the resistor string part 215f.

When the second transistor TR2 is turned on, the second resistor part 215d is in a shorted state such that a resistance value is substantially zero, in accordance with parallel resistor characteristics. When the second transistor TR2 is turned off, the second resistor part 215d includes a resistance value equal to that of the lower resistor RL.

The control terminal 215e is electrically connected to a gate terminal of the first and second transistors TR1 and TR2, and the control terminal 215e receives the line inversion signal POL. The line inversion signal POL controls an operation of the first and second transistors TR1 and TR2.

The resistor string part 215f includes a plurality of resistors R0 to Rn+1 which are coupled to each other in series. A plurality of output terminals is formed between the resistors R0 to Rn+1. The resistor string part 215f divides the first and second power voltages Vb and Vw, which are applied to the first and second power terminals 215a and 215c, respectively, into a plurality of gamma voltages Vg0, Vg1, . . . , Vgn−1 and Vgn.

The resistor string part 215f generates a plurality of negative gamma voltages or a plurality of positive gamma voltages with respect to the reference voltage in accordance with the line inversion signal POL and the first and second power voltages Vb and Vw.

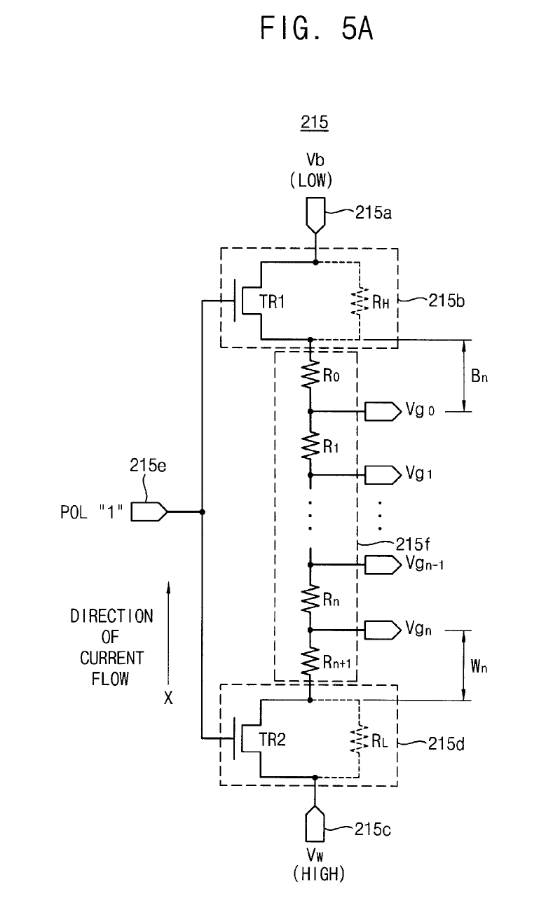

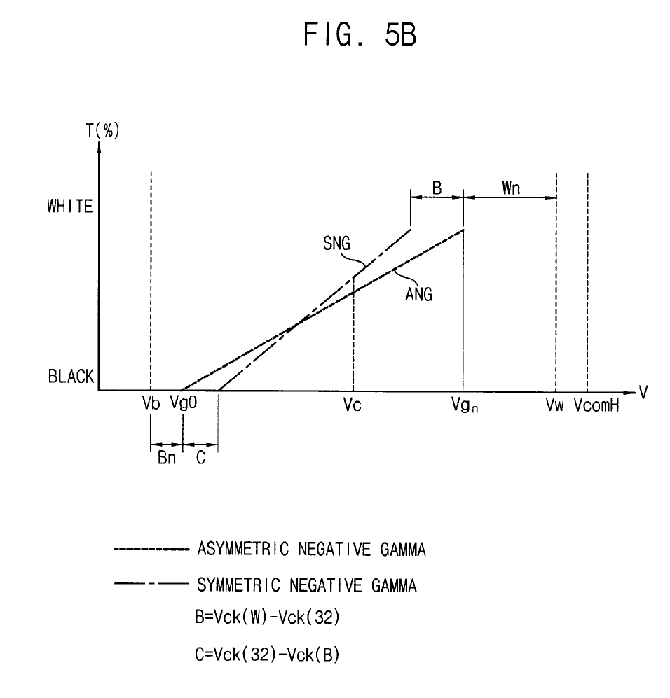

In an exemplary embodiment, when the line inversion signal POL is ‘1’, and a level of the first power voltage Vb is less than that of the second power voltage Vw, the resistor string part 215f generates the negative gamma voltages, as illustrated in FIG. 5A. In an exemplary embodiment, a low gradation gamma voltage Vg0 with the negative polarity is generated based on the first resistor part 215b and a first resistor R0 of the resistor string part 215f, and a high gradation gamma voltage Vgn with the negative polarity is generated based on the second resistor part 215d and an (n+1)-th resistor Rn+1 of the resistor string part 215f. A plurality of halftone gamma voltages Vg1 to Vgn−1 of the remaining first polarity is generated by the resistor string part 215f.

The first and second transistors TR1 and TR2 are turned on to be in an electrically shorted state. Therefore, each of the first and second resistor parts 215b and 215d includes a resistance value similar to a resistance value of the first and second transistors TR1 and TR2, respectively. Therefore, the low and high gradation gamma voltages Vg0 and Vgn with the negative polarity are generated based on the first resistor R0 and the (n+1)-th resistor Rn+1, respectively.

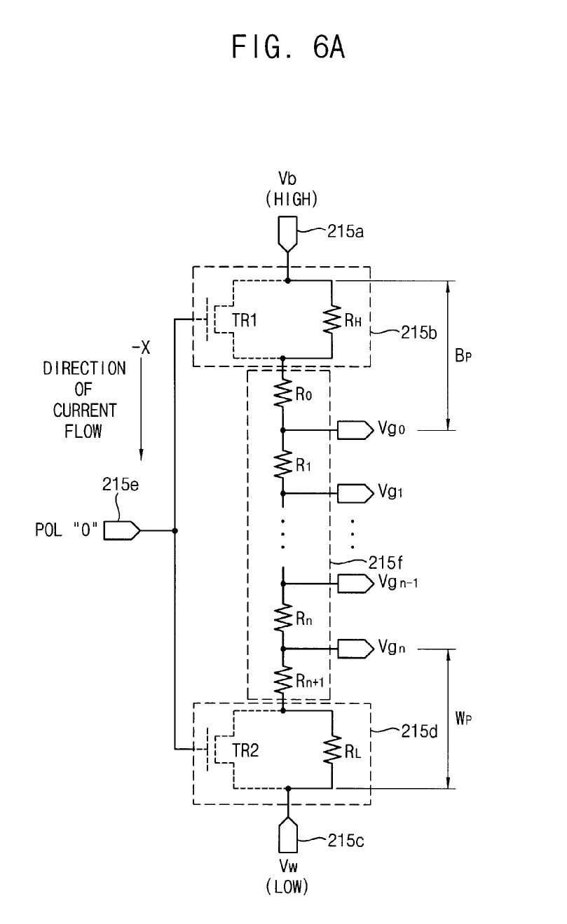

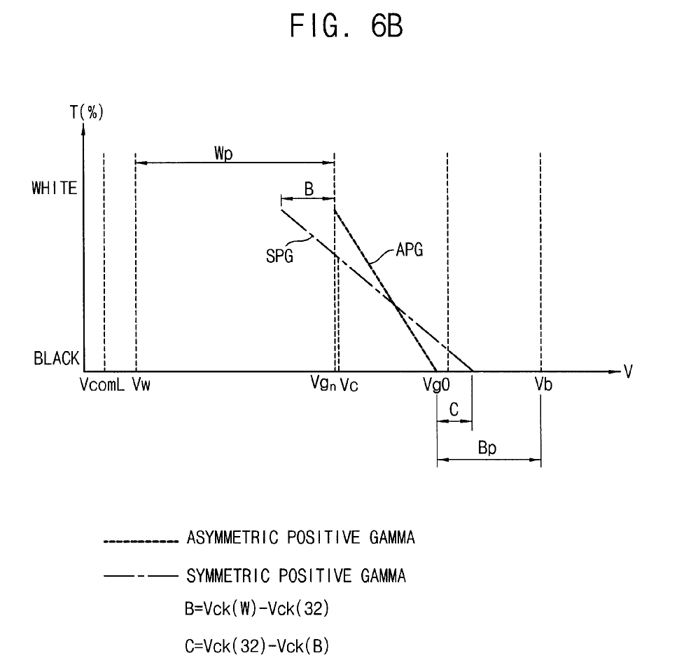

When the line inversion signal POL is ‘0’, and a level of the first power voltage Vb is greater than that of the second power voltage Vw, the resistor string part 215f generates the positive gamma voltages, as illustrated in FIG. 6A.

In an exemplary embodiment, the first and second transistors TR1 and TR2 are turned off to be in an electrically open state. A low gradation gamma voltage Vg0 with the positive polarity is generated based on an upper resistor RH of the first resistor part 215b and a first resistor R0 of the resistor string part 215f, and a high gradation gamma voltage Vgn with a second polarity is generated based on a lower resistor RL of the second resistor part 215d and an (n+1)-th resistor Rn+1 of the resistor string part 215f. A plurality of halftone gamma voltages Vg1 to Vgn−1 with the remaining second polarity is generated by the resistor string part 215f.

The gamma voltages Vg0, Vg1, . . . , Vgn−1 and Vgn generated by the gamma voltage generating part 215 are provided to the source driving part 230. The source driving part 230 includes a gradation voltage generating part 230a.

The gradation voltage generating part 230a includes a resistor string including a plurality of resistors R0 to Rk which are electrically connected in series. Each of the gamma voltages Vg0, Vg1, . . . , Vgn−1 and Vgn is applied to the resistors R0, . . . , Rk, respectively, such that a plurality of gradation voltages, for example, 64 gradation voltages V0, V1, . . . , V62 and V63 corresponding to the total gradation is generated. However, the present invention is not limited to only 64 gradation voltages.

In exemplary embodiments, the source driving part 230 may include a digital-to-analog converter (“DAC”) (not shown). The DAC outputs one of the gradation voltages V0, V1, . . . , V62 and V63 generated by the gradation voltage generating part 230a based on a gradation voltage corresponding to an inputted data signal. In an exemplary embodiment, when the DAC receives a “000_{—}011” data signal of 6 bits, the DAC outputs ‘V2’ which is a gradation voltage of 3 gradations.

Hereinafter, an exemplary embodiment of a driving method of the gamma voltage generating part 215 will be described in detail with reference to the following FIGS. 5A and 5B.

FIG. 5A is a circuit schematic diagram illustrating the gamma voltage generating part of FIG. 3 operating in a first mode. FIG. 5B is a graph illustrating a voltage-transmittance (“V-T”) curve with a first polarity in the first mode shown in FIG. 5A.

Referring to FIGS. 2 and 5A, during an (N)-th horizontal interval, the display panel receives a first common voltage VcomH which is larger than a common voltage Vc.

First and second power voltages Vb and Vw are applied to first and second power terminals 215a and 215c of the gamma voltage generating part 215, respectively, and the line inversion signal POL of ‘1’ is applied to a control terminal 215e. A level of the first power voltage Vb applied to the first power terminal 215a is less than that of the reference voltage Vc, and a level of the second power voltage Vw applied to the second power terminal 215c is greater than the reference voltage Vc. The first and second power voltage Vb and Vw include a phase opposite to the reference voltage Vc. A voltage difference between the first power voltage Vb and the reference voltage is substantially equal to a voltage difference between the second power voltage Vw and the reference voltage.

As the line inversion signal POL of ‘1’ is applied to the control terminal 215e, the first and second transistors TR1 and TR2 are turned on such that the first and second resistor parts 215b and 215d are in a shorted state, such that a resistance value is substantially zero. In FIG. 5A, a dotted line denotes the shorted first and second resistor parts 215a and 215d.

A level of the first power voltage Vb is less than that of the first power voltage Vw, such that a current flows along a direction X in the gamma voltage generating part 215, as illustrated in FIG. 5A. The resistor string part 215f divides the first and second power voltages Vb and Vw into n gamma voltages Vg0, Vg1, Vgn−1 and Vgn. In the current exemplary embodiment, the n gamma voltages may satisfy the following relation: Vg0<Vg1< . . . <Vgn−1<Vgn.

In FIG. 5B, a first polarity V-T curve of a symmetric negative gamma (“SNG”) type and a first polarity V-T curve of an asymmetric negative gamma (“ANG”) type are illustrated. Referring to FIG. 5B, the SNG V-T curve is obtained when a kickback voltage corresponding to a halftone, for example, a kickback voltage Vck(32) corresponding to 32 gradations of 64 gradations, is adopted for all gradations.

The asymmetric V-T curve ANG is a V-T curve in which a kickback voltage Vck(W) corresponding to a white gradation and a kickback voltage Vck(B) corresponding to a black gradation are adopted in the symmetric V-T curve SNG. When the asymmetric V-T curve ANG and the symmetric V-T curve SNG are compared, a level of a high gradation gamma voltage Vgn is moved by a difference ‘B’ between a kickback voltage Vck(W) corresponding to the white gradation and a kickback voltage Vck(32) corresponding to the halftone, and a level of a low gradation gamma voltage Vg0 is moved by a difference ‘C’ between a kickback voltage Vck(32) corresponding to the halftone and a kickback voltage Vck(B) corresponding to the black gradation.

Therefore, in exemplary embodiments, in the resistor string part 215f, a voltage difference between two terminals of the first resistor R0 may be set to be ‘Bn’, and a voltage difference between two terminals of the (n+1)-th resistor Rn+1 may be set to be ‘Wn’, as shown in FIG. 5B.

When the gamma voltage generating part 215 is operated in a first mode, operation conditions of the gamma voltage generating part 215 are summarized in the following Table 1.

TABLE 1

| | | | | Range of a | | |
|---|---|---|---|---|---|---|
| | | | State of | Gamma | | |
| Mode | | | TR1 and | Voltage | | |
| (Polarity) | Vcom | POL | TR2 | (Vg0 to Vgn) | Vb | Vw |
| First Mode | High | 1 | Shorted | (Vb + Bn) | Low | High |
| (Negative) | | | | to (Vw − Wn) | | |

FIG. 6A is a circuit schematic diagram illustrating the gamma voltage generating part of FIG. 3 operating in a second mode. FIG. 6B is a V-T curve of a second polarity in the second mode shown in FIG. 6A.

Referring to FIGS. 2 and 6A, during an (N+1)-th horizontal interval, the display panel receives a second common voltage VcomL which is lower than the common voltage Vc.

First and second power voltages Vb and Vw are applied to the first and second power terminals 215a and 215c of the gamma voltage generating part 215, respectively, and the line inversion signal POL of ‘0’ is applied to the control terminal 215e. A level of the first power voltage Vb which is applied to the first power terminal 215a is greater than that of the reference voltage Vc, and a level of the second power voltage Vw which is applied to the second power terminal 215c is less than the reference voltage Vc. The first and second power voltages Vb and Vw include a phase opposite to the reference voltage Vc. A voltage difference between the first power voltage Vb and the reference voltage Vc is substantially equal to a voltage difference between the second power voltage Vw and the reference voltage Vc.

As the line inversion signal POL of ‘0’ is applied to the control terminal 215e, the first and second transistors TR1 and TR2 are turned off. In FIG. 6A, a dotted line denotes the first and second transistors TR1 and TR2 which are turned off. Therefore, the first resistor part 215b includes a resistance value corresponding to the upper resistor RH, and the second resistor part 215d includes a resistance value corresponding to the lower resistor RL.

A level of the first power voltage Vb is greater than that of the second power voltage Vw, such that a current flows along a direction X in the gamma voltage generating part 215, as illustrated in FIG. 6A. The resistor string part 215f divides the first and second power voltages Vb and Vw into n gamma voltages Vg0, Vg1, Vgn−1 and Vgn. In the current exemplary embodiment, the n gamma voltages may satisfy the following relation: Vg0>Vg1> . . . >Vgn−1>Vgn.

In FIG. 6B, a second polarity V-T curve of a symmetric positive gamma (“SPG”) type and a second polarity V-T curve of an asymmetric (“APG”) type are illustrated. Referring to FIG. 6B, the symmetric V-T curve SPG is obtained when a kickback voltage corresponding to a halftone, for example, a kickback voltage Vck(32) corresponding to 32 gradations of 64 gradations, is adopted for all gradations.

The asymmetric V-T curve APG is a V-T curve in which a kickback voltage Vck(W) corresponding to a white gradation and a kickback voltage Vck(B) corresponding to a black gradation are adopted in the symmetric V-T curve SPG. When the asymmetric V-T curve APG and the symmetric V-T curve SPG are compared, a level of a high gradation gamma voltage Vgn is moved by a difference ‘B’ between a kickback voltage Vck(W) corresponding to the white gradation and a kickback voltage Vck(32) corresponding to the halftone, and a level of a low gradation gamma voltage Vg0 is moved by a difference ‘C’ between a kickback voltage Vck(32) corresponding to the halftone and a kickback voltage Vck(B) corresponding to the black gradation.

Therefore, in exemplary embodiments, a voltage difference between the upper resistor RH and the first resistor R0 may be set to be ‘Bp’, and a voltage difference between the lower resistor RL and the (n+1)-th resistor Rn+1 may be set to be ‘Wp’, as shown in FIG. 6B.

When the gamma voltage generating part 215 is operated in a second mode, operation conditions of the gamma voltage generating part 215 are summarized in the following Table 2.

TABLE 2

| | | | State | Range of | | |
|---|---|---|---|---|---|---|
| | | | of TR1 | a Gamma | | |
| Mode | | | and | Voltage | | |
| (Polarity) | Vcom | POL | TR2 | (Vg0 to Vgn) | Vb | Vw |
| Second Mode | Low | 0 | Open | (Vw + Wp) | High | Low |
| (Positive) | | | | to (Vb − Bp) | | |

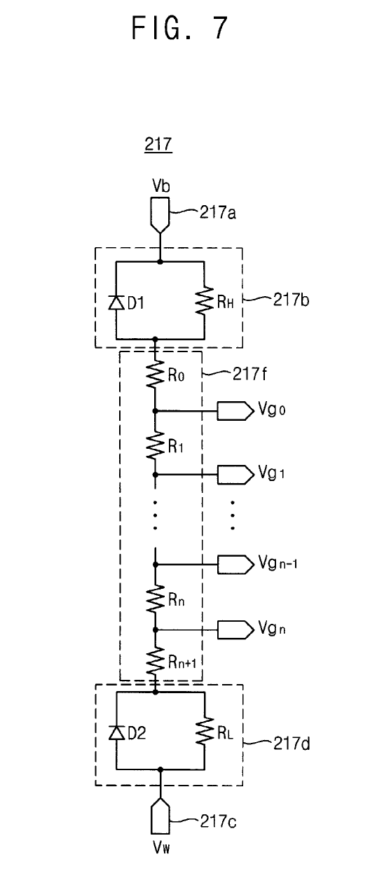

FIG. 7 is a circuit schematic diagram according to a second exemplary embodiment of the gamma voltage generating part of FIG. 2.

Referring to FIG. 7, a gamma voltage generating part 217 includes a first power terminal 217a, a first resistor part 217b, a second power terminal 217c, a second resistor part 217d and a resistor string part 217f.

The first power terminal 217a receives the first power voltage Vb.

The first resistor part 217b includes a first diode D1 and an upper resistor RH which are electrically connected in parallel. The first resistor part 217b is electrically connected in series to the first power terminal 217a and to a first terminal of the resistor string part 217f. In an exemplary embodiment, a cathode of the first diode D1 is electrically connected to the first power terminal 217a, and an anode of the first diode D1 is electrically connected to the second power terminal 217c.

In the first resistor part 217b, when a forward direction voltage is applied to the first diode D1, the first diode D1 is in an electrically shorted state. Therefore, the first resistor part 217b includes a resistance value similar to a resistance value of the first diode D1. Alternatively, when a reverse direction voltage is applied to the first diode D1, the first diode D1 is in an electrically shorted state such that the first resistor part 217b includes a resistance value equal to that of the upper resistor RH.

The second power terminal 217c receives the second power voltage Vw including an opposite phase to the first power voltage Vb and a same voltage difference as the first power voltage Vb with respect to the reference voltage Vc.

The second resistor part 217d includes a second diode D2 and a lower resistor RL which are electrically connected in parallel. The second resistor part 217d is electrically connected in series to the second power terminal 217c and a second terminal of the resistor string part 217f. In an exemplary embodiment, a cathode of the second diode D2 is electrically connected to the first power terminal 217a, and an anode of the first diode D1 is electrically connected to the second power terminal 217c.

In the second resistor part 217d, when a forward direction voltage is applied to the second diode D2, the second diode D2 is in an electrically shorted state. Therefore, the second resistor part 217d includes a resistance value similar to a resistance value of the second diode D2. Alternatively, when a reverse direction voltage is applied to the second diode D2, the second diode D2 is in an electrically shorted state such that the second resistor part 217d includes a resistance value equal to that of the lower resistor RL.

The resistor string part 217 includes a plurality of resistors R0 to Rn+1 which are coupled to each other in series. A plurality of output terminals is formed between the resistors R0 to Rn+1. The resistor string part 217f divides the first and second power voltages Vb and Vw into a plurality of gamma voltages Vg0, Vg1, Vgn−1 and Vgn.

The resistor string part 217f generates a plurality of positive gamma voltages or a plurality of negative gamma voltages Vg0, Vg1, . . . , Vgn−1 and Vgn with respect to the reference voltage in accordance with the first and second power voltages Vb and Vw which are applied from the first and second power terminals 217a and 217c, respectively.

When the first power voltage Vb, which is less than the second power voltage Vw which is applied to the second power terminal 217c, is applied to the first power terminal 217a, the gamma voltage generating part 217 generates the negative gamma voltages using the first diode D1, the resistor string part 217 and the second diode D2.

In an exemplary embodiment, the negative low gradation gamma voltage Vg0 is generated based on the first diode D1 and the first resistor R0 of the first resistor string part 215f, and the negative high gradation gamma voltage Vgn is generated based on the second diode D2 and the (n+1)-th resistor Rn+1 of the resistor string part 215f. A plurality of halftone gamma voltages Vg1 to Vgn−1 of the remaining negative polarity is generated by the resistors R1 to Rn of the resistor string part 217f.

When the first power voltage Vb, which is greater than the second power voltage Vw which is applied to the second power terminal 217c, is applied to the first power terminal 217a, the gamma voltage generating part 217 generates the positive gamma voltages using the upper resistor RH, the resistor string part 217f and the lower resistor RL.

In an exemplary embodiment, the positive low gradation gamma voltage Vg0 is generated based on the upper resistor RH and the first resistor R0 of the resistor string part 217f, and the positive high gradation gamma voltage Vgn is generated based on the lower resistor RL and the (n+1)-th resistor Rn+1 of the resistor string part 215f. A plurality of halftone gamma voltages Vg1 to Vgn−1 of the remaining positive polarity is generated by the resistors R1 to Rn of the resistor string part 217f.

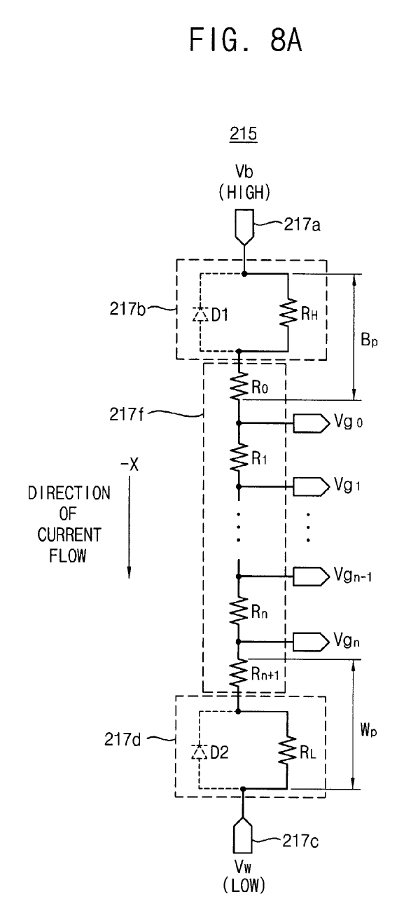

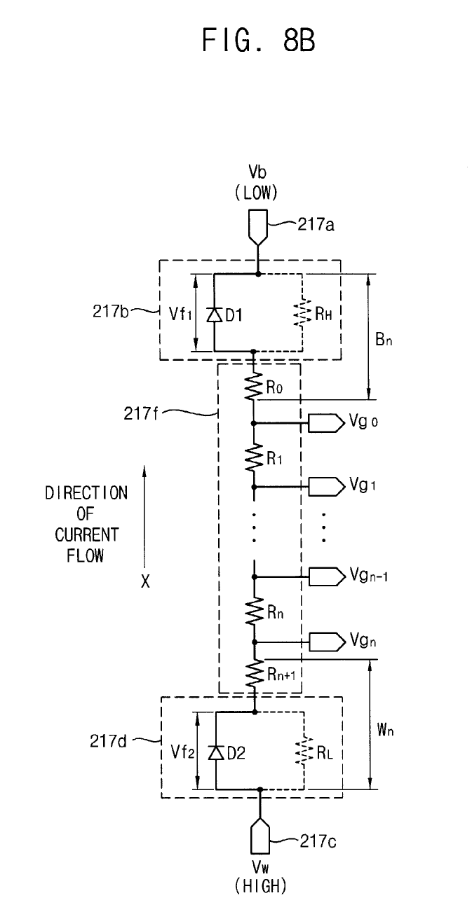

FIG. 8A is a circuit schematic diagram illustrating the exemplary embodiment of the gamma voltage generating part of FIG. 7 operating in a first mode.

Referring to FIG. 8A, during an (N)-th horizontal interval, the display panel receives a first common voltage VcomH which is larger than a common voltage Vc.

Each of first and second power voltages Vb and Vw is applied to the first and second power terminals 217a and 217c of the gamma voltage generating part 217, respectively. A level of the first power voltage Vb which is applied to the first power terminal 217a is less than the reference voltage Vc, and a level of the second power voltage Vw which is applied to the second power terminal 217c is greater than the reference voltage Vc. The first and second power voltages Vb and Vw include a phase opposite to the reference voltage Vc. A voltage difference between the first power voltage Vb and the reference voltage Vc is substantially equal to a voltage difference between the second power voltage Vw and the reference voltage Vc.

Since a level of the first power voltage Vb is less than a level of the second power voltage Vw, a current flows along a direction X in the gamma voltage generating part 215, as illustrated in FIG. 8A. A forward voltage is applied to the first and second diodes D1 and D2, and each of the first and second resistor parts 217b and 217d includes a resistance value of the first diode D1 and a resistance value of the second diode D2, respectively.

Therefore, the gamma voltage generating part 217 divides the first and second power voltages Vb and Vw into n gamma voltages Vg0, Vg1, . . . , Vgn−1 and Vgn using the first diode D1, the resistor string part 217f and the second diode D2, and outputs the divided gamma voltages Vg0, Vg1, . . . , Vgn−1 and Vgn. In the current exemplary embodiment, the n gamma voltages may satisfy the following relation: Vg0<Vg1< . . . <Vgn−1<Vgn.

Referring to FIG. 5B, in an exemplary embodiment, a resistance value of the first resistor R0 may be set so as to be based on ‘Bn,’ which is a voltage difference between the first diode D1 and the first resistor R0, and a resistance value of the (n+1)-th resistor Rn+1 may be set so as to be based on ‘Wn,’ which is a voltage difference between the second diode D2 and the (n+1)-th resistor Rn+1. In an exemplary embodiment, each forward voltage drop Vf1 and Vf2 is generated in the first and second diodes D1 and D2, respectively, such that the first resistor R0 and the (n+1)-th resistor Rn+1 may be set based on the forward voltage drops Vf1 and Vf2.

When the gamma voltage generating part 217 is operated in a first mode, operation conditions of the gamma voltage generating part 217 are summarized in the following Table 3.

TABLE 3

| | | | Range of a | | |
|---|---|---|---|---|---|
| Mode | | State of D1 and | Gamma Voltage | | |
| (Polarity) | Vcom | D2 | (Vg0 to Vgn) | Vb | Vw |
| First Mode | High | Shorted | (Vb + Bn) | Low | High |
| (Negative) | | | to (Vw − Wn) | | |

FIG. 8B is a circuit schematic diagram illustrating the gamma voltage generating part of FIG. 7 operating in a second mode.

Referring to FIG. 8B, during an (N+1)-th horizontal interval, the display panel receives a second common voltage VcomL which is lower than a common voltage Vc.

First and second power voltages Vb and Vw are applied to first and second power terminals 217a and 217c of the gamma voltage generating part 217, respectively. A level of the first power voltage Vb is greater than that of the reference voltage Vc, and a level of the second power voltage Vw is less than the reference voltage Vc. The first and second power voltages Vb and Vw include a phase opposite to the reference voltage Vc. A voltage difference between the first power voltage Vb and the reference voltage is substantially equal to a voltage difference between the second power voltage Vw and the reference voltage. The level of the first power voltage Vb is greater than that of the second power voltage Vw, such that a current flows along a direction X in the gamma voltage generating part 215, as illustrated in FIG. 8B.

When an inverse voltage is applied to the first and second diodes D1 and D2, each of the first and second resistor parts 217b and 217d includes a resistance value equal to that of the upper resistor RH and a resistance value equal to that of the lower resistor RL, respectively.

Therefore, the gamma voltage generating part 217 divides the first and second power voltages Vb and Vw into n gamma voltages Vg0, Vg1, . . . , Vgn−1 and Vgn using the upper resistor RH, the resistor string part 217f and the lower resistor RL, and outputs the divided gamma voltages Vg0, Vg1, . . . , Vgn−1 and Vgn. In the current exemplary embodiment, the n gamma voltages may satisfy the following relation: Vg0>Vg1> . . . >Vgn−1>Vgn.

Referring to FIG. 6B, in an exemplary embodiment, a resistance value of the first resistor R0 may be set so as to be based on ‘Bp,’ which is a voltage difference between the upper resistor RH and the first resistor R0 which are electrically connected in series, and a resistance value of the (n+1)-th resistor Rn+1 may be set, so as to be based on ‘Wp,’ which is a voltage difference between the lower resistor RL and the (n+1)-th resistor Rn+1 which are electrically connected in series.

When the gamma voltage generating part 216 is operated in a second mode, operation conditions of the gamma voltage generating part 217 are summarized in the following Table 4.

TABLE 4

| | | State of | | | |
|---|---|---|---|---|---|
| Mode | | D1 and | Range of a Gamma | | |
| (Polarity) | Vcom | D2 | Voltage (Vg0 to Vgn) | Vb | Vw |
| Second Mode | Low | Open | (Vw + Wp) | High | Low |
| (Positive) | | | to (Vb − Bp) | | |

As described above, according to exemplary embodiments of the present invention, first and second polarity gamma voltages may be alternately generated in synchronization with a horizontal synchronizing signal using a gamma voltage generating circuit including one resistor string. Therefore, a circuit for generating the gamma voltages may be simplified and manufacturing costs may be decreased. Furthermore, as an asymmetric V-T curve is adapted to the gamma voltage generating circuit, display quality problems, such as flickering, afterimages, etc. may be improved.

Although some exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A gamma voltage generating circuit comprising:
a resistor string part including a plurality of resistors connected in series between a first power terminal receiving a first power voltage and a second power terminal receiving a second power voltage, the resistor string part outputting a plurality of gamma voltages;
a first resistor part including a first electronic device connected in parallel with a first resistor, the first resistor part being connected in series between the first power terminal and a first terminal of the resistor string part; and
a second resistor part including a second electronic device connected in parallel with a second resistor, the second resistor part being connected in series between the second power terminal and a second terminal of the resistor string part.

2. The gamma voltage generating circuit of claim 1, wherein the first power voltage includes an opposite phase to the second power voltage with respect to a reference voltage.

3. The gamma voltage generating circuit of claim 2, wherein each of the first and second electronic devices is electrically shorted when the first power voltage is less than the second power voltage.

4. The gamma voltage generating circuit of claim 3, wherein the resistor string part outputs a plurality of gamma voltages of a first polarity.

5. The gamma voltage generating circuit of claim 2, wherein each of the first and second electronic devices is electrically opened when the first power voltage is greater than the second power voltage.

6. The gamma voltage generating circuit of claim 5, wherein the resistor string part outputs a plurality of gamma voltages of a second polarity.

7. The gamma voltage generating circuit of claim 1, wherein each of the first and second electronic devices includes a first transistor and a second transistor, respectively.

8. The gamma voltage generating circuit of claim 7, wherein the first and second transistors are controlled in accordance with a line inversion signal of a display device.

9. The gamma voltage generating circuit of claim 1, wherein each of the first and second electronic devices comprises a first diode and a second diode, respectively.

10. The gamma voltage generating circuit of claim 9, wherein each of the first and second diode comprises a cathode connected to the first power terminal and an anode connected to the second power terminal.

11. A display device comprising:
a display panel including a pixel part connected to a source line and a gate line crossing the source line, the pixel part including a liquid crystal capacitor;
a voltage generating part which provides the liquid crystal capacitor with a first common voltage and a second common voltage which are inverted with respect to a reference voltage; and
a gamma voltage generating part which generates one of a plurality of first polarity gamma voltages and a plurality of second polarity gamma voltages, the gamma voltage generating part comprising:
a resistor string part including a plurality of resistors connected in series between a first power terminal receiving a first power voltage and a second power terminal receiving a second power voltage;
a first resistor part including a first electronic device connected in parallel with a first resistor, the first resistor part being connected to a first terminal of the resistor string part; and
a second resistor part including a second electronic device connected in parallel with a second resistor, the second resistor part being connected to a second terminal of the resistor string part.

12. The display device of claim 11, wherein the voltage generating part outputs the first and second common voltages in synchronization with a horizontal synchronizing signal, and
the gamma voltage generating part outputs the gamma voltages with the first polarity and the gamma voltages with the second polarity in synchronization with a horizontal synchronizing signal.

13. The display device of claim 12, wherein the voltage generating part generates a first power voltage and a second power voltage, the first power voltage and the second power voltage have an opposite phase to the reference voltage.

14. The display device of claim 13, wherein each of the first and second electronic devices is electrically shorted when the first power voltage is less than the second power voltage.

15. The display device of claim 14, wherein the resistor string part outputs the first polarity gamma voltages having a lower level than the first common voltage.

16. The display device of claim 13, wherein each of the first and second electronic devices is electrically opened when the first power voltage is larger than the second power voltage.

17. The display device of claim 16, wherein the resistor string part outputs the second polarity gamma voltages having a larger level than the second common voltage.

18. The display device of claim 12, further comprising:
a timing control part which outputs a line inversion signal synchronized with the horizontal synchronizing signal,
wherein each of the first and second electronic devices include a first transistor and a second transistor, respectively.

19. The display device of claim 12, wherein each of the first and second electronic devices includes a first diode and a second diode, respectively.

20. The display device of claim 19, wherein each of the first and second diode includes a cathode connected to the first power terminal and an anode electrically connected to the second power terminal.
